(19) United States
(12) Patent Application Publication
(10) Pub. No.: US 2024/0273434 A1
(43) Pub. Date: Aug. 15, 2024

(54) DIGITAL TWIN MODELLING USING TASK KEYWORD ANALYSIS

(71) Applicant: International Business Machines Corporation, Armonk, NY (US)

(72) Inventors: Peng Hui Jiang, Beijing (CN); Dong Hui Liu, Beijing (CN); Jia Tian Zhong, Beijing (CN); Xing Xing Shen, Beijing (CN); Jing Lu, Beijing (CN); Jia Yu, Beijing (CN); Yong Yin, Beijing (CN); Xiao Yan Tang, Beijing (CN)

(73) Assignee: International Business Machines Corporation, Armonk, NY (US)

(21) Appl. No.: 18/107,787

(22) Filed: Feb. 9, 2023

(51) Int. Cl. G06Q 10/0633; G06Q 10/067

(52) U.S. Cl. CPC G06Q 10/0633; G06Q 10/067

(57) ABSTRACT

A set of tasks is extracted from workflow data of a system. A set of keywords is extracted from a task in the set of tasks. The set of keywords is expanded into an expanded set of keywords, the expanded set of keywords comprising a new keyword with a semantic relationship to a keyword in the set of keywords. A new task is generated using the expanded set of keywords. Based on a result of execution of the new task, a model of the system is adjusted, the model comprising the workflow data, the set of tasks, and the expanded set of keywords.

### BACKGROUND

The present invention relates generally to a method, system, and computer program product for digital twin modelling. More particularly, the present invention relates to a method, system, and computer program product for digital twin modelling using task keyword analysis.

A digital twin is a virtual model designed to accurately reflect a physical entity, for example a data center, a business, or a city. The physical entity being modelled typically includes various sensors or other means of monitoring the physical entity's functionality and performance. This data is then relayed to a processing system and applied to the digital copy. Using this data, the digital twin model can be used to monitor and analyze aspects of the modelled entity, forecast future needs, and simulate changes to the modelled entity such as “what if” scenarios and alternative processes. If a modelled change proves to be an improvement, the change can be applied to improve the modelled entity.

### SUMMARY

The illustrative embodiments provide a method, system, and computer program product. An embodiment includes a method that extracts, from workflow data of a system, a set of tasks. An embodiment extracts, from a task in the set of tasks, a set of keywords. An embodiment expands, into an expanded set of keywords, the set of keywords, the expanded set of keywords comprising a new keyword with a semantic relationship to a keyword in the set of keywords. An embodiment generates, using the expanded set of keywords, a new task. An embodiment adjusts, based on a result of execution of the new task, a model of the system, the model comprising the workflow data, the set of tasks, and the expanded set of keywords.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for digital twin modelling using task keyword analysis in accordance with an illustrative embodiment;

FIG. 3 depicts an example of digital twin modelling using task keyword analysis in accordance with an illustrative embodiment;

FIG. 4 depicts a continued example of digital twin modelling using task keyword analysis in accordance with an illustrative embodiment;

FIG. 5 depicts a continued example of digital twin modelling using task keyword analysis in accordance with an illustrative embodiment;

FIG. 6 depicts a continued example of digital twin modelling using task keyword analysis in accordance with an illustrative embodiment;

FIG. 7 depicts a continued example of digital twin modelling using task keyword analysis in accordance with an illustrative embodiment;

FIG. 8 depicts a flowchart of an example process for digital twin modelling using task keyword analysis in accordance with an illustrative embodiment.

### DETAILED DESCRIPTION

The illustrative embodiments recognize that the utility of a digital twin model is due to the fidelity with which the model represents the physical entity being modelled. However, the entity being modelled is also changing in real time. For example, the rotation rate of a modelled wind turbine (and thus, the power being generated) varies with wind speed. As another example, processing workloads on the systems in a data center being modelled vary as executing applications start, end, and process differing amounts of data at different times. Consequently, developing and maintaining such models is too complex for humans to perform, especially in real time, and requires an automated implementation. In addition, the entity being modelled may not be well documented, or the documentation may not be reliable. Thus, the illustrative embodiments recognize that there is a need to perform digital twin modelling in an automated fashion, by analyzing data of the entity being modelled.

The illustrative embodiments recognize that the presently available tools or solutions do not address these needs or provide adequate solutions for these needs. The illustrative embodiments used to describe the invention generally address and solve the above-described problems and other problems related to digital twin modelling using task keyword analysis.

An embodiment can be implemented as a software application. The application implementing an embodiment can be configured as a modification of an existing digital twin modelling system, as a separate application that operates in conjunction with an existing digital twin modelling system, a standalone application, or some combination thereof.

Particularly, some illustrative embodiments provide a method that extracts a set of tasks from workflow data, extracts a set of keywords from a task, expands the set of keywords to include a new keyword with a semantic relationship to a keyword in the set of keywords, uses the expanded set of keywords to generate a new task, and adjusts, based on a result of execution of the new task, a model.

An embodiment receives workflow data of an entity or system to be modelled. Workflow data is data of work an entity or system to be modelled performs. Some non-limiting examples of workflow data are lifecycle data of components of the entity, organization data of an organization managing the entity, amounts and types of physical objects and data entering the entity, moving internally among portions of the entity, and exiting the entity, as well as data of the manner in which portions of the entity affect other portions of the entity and data of an environment of the entity. For example, in a data center being modelled, workflow data might include data entering and exiting systems installed in the data center, data of a current state of each of the systems and the building in which the systems are located, and current and forecast weather for the area in which the data center is located.

An embodiment extracts a set of tasks from workflow data. A task is a unit of work performed on the workflow generating the workflow data. In particular, an embodiment generates a task name, a text string uniquely identifying a task. An embodiment generates a natural language description of a task. An embodiment generates an action, a modification of the environment caused by the execution of a task. An embodiment generates one or more preconditions, Boolean expressions that must be true before the action(s) of the task can take place. An embodiment generates one or more postconditions, Boolean expressions that must be true after the action(s) of the task take place. An embodiment generates one or more attributes or characteristics of a task, which indicate the type and quantity of resources necessary for the execution of the task, ab actor responsible for the task, the task's security requirements, whether or not the task is reversible, and the like. An embodiment generates one or more exceptions, which provide information on how to handle abnormal events, typically in <event, action> pairs. Techniques to extract a set of tasks from workflow data—Zeebe, for example—are presently available. (Zeebe is a registered trademark of Camunda Services GmbH in the United States and other countries.)

For example, consider a data center being modelled. From workflow data of the data center, an embodiment might identify “submit initial workload” and “generate more workload” tasks, generated by a client of the data center. An embodiment might identify a “perform workload” task, in which servers of the data center perform workload submitted by a client, and a “risk analysis” task in which risks to the servers are evaluated. An embodiment might identify two tasks of the building's heating, ventilation, and air conditioning (HVAC) system: “collect metrics” (e.g., of the temperature of a server room) and “adjust temperature”. In addition, an embodiment might identify a “review dashboard” task performed by a human responsible for monitoring the data center being modelled. The “adjust temperature” task might include a task name of “adjust temperature” and attributes including HVAC control, Data Center 1, if room temperature is low, activate heat, and if room temperature is high, activate air conditioning (AC). An input condition of the “adjust temperature” task might be that the room temperature is greater than 1° C. different from the room's target temperature. An output condition of the “adjust temperature” task might be that the room temperature equals the target temperature. Actors of the task might include one heating unit, and one AC unit. Other conditions of the task might be that a room temperature sensor is needed, the task is reversible, and that the building maintenance team is responsible for the task.

An embodiment extracts a set of keywords from a task. Keywords are informative words that indicate content. For example, for a task named “adjust the temperature”, “adjust” and “temperature” are keywords because they convey information about the task, but “the” does not convey information about this task in particular and thus is not a keyword. Keywords need not be single complete words, and can also be word fragments and multi-word phrases. Keywords need not all be in the same human language. Techniques to extract a set of keywords from a task-for example, using a natural language processing engine-are presently available

An embodiment expands the set of keywords by including one or more new keywords with a semantic relationship to a keyword already in the set of keywords. Some non-limiting examples of semantic relationships between keywords are synonyms of a keyword, antonyms of a keyword, variations of a keyword (e.g., variant spellings or different endings of the same root word), homonyms of a keyword, typical collocations and associations (i.e., additional words typically found in proximity to or otherwise associated with a keyword), derivatives of a keyword, phrases that include a keyword, actions or phenomena that typically affect a keyword, and the like. For example, for the keyword “adjust”, some additional keywords might be “increase”, “decrease”, “turn up”, “turn down”, and “alter” (all synonyms). As another example, for the keyword “temperature” some additional keywords might be “raised temperature”, “lowered temperature”, “suitable temperature”, “constant temperature”, “body temperature”, “air temperature”, “room air temperature”, “snow”, “ice”, “thermometer”, and “fire”.

One embodiment maintains a repository of keywords for use as new keywords. Another embodiment uses an already-existing repository of keywords as a source of new keywords.

Workflow data, tasks extracted from workflow data, and the expanded set of keywords are collectively referred to as a model. The model is searchable by matching a keyword, phrase, or text string, and by using a keyword as a term. The model is also usable to generate a forecast of a future state of the workflow being modelled, for example of when maintenance will be required on a modelled component or when an amount of material will be needed.

Because the model includes proprietary data of a business, one embodiment maintains model data in a private cloud or other system accessible to those authorized to view and use the business' proprietary data. Another embodiment maintains the model in two portions: workflow data, tasks extracted from workflow data, and keywords extracted from tasks are maintained in a private cloud or other access-restricted system, while deduced data (i.e., keywords deduced from the original keywords extracted from tasks) are maintained in a public cloud or other publicly-available system. One embodiment maintains both portions in the same format, for ease of use.

An embodiment uses the expanded set of keywords to generate a new task. In one embodiment, the new task is a variation of an existing task, such as an addition, removal, or substitution of a keyword in a task attribute, input or output condition, actor, or other portion of data describing a task. For example, an embodiment might generate a variation of an “adjust temperature” task with a task name of “adjust workload” and attributes including if room temperature is high, reduce server workload (e.g., by moving some workload to another data center), and the same input conditions as the original “adjust temperature” task. Presently available task extraction tools such as Zeebe include an ability to generate variations of an existing task using additional keywords.

An embodiment simulates execution of the generated task, in isolation or as part of a workflow being modelled. Techniques to simulate task execution are presently available. If a result of the simulation meets a success criterion, an embodiment causes execution of the generated task in the entity being modelled. If a result of the simulation does not meet a success criterion, an embodiment uses the simulation results to generate a different variation of the task and repeats the simulation and evaluation.

If execution of the generated task in the entity being modelled meets a success criterion and consequently the generated task is implemented in the entity being modelled, an embodiment adjusts the model to include the generated task and its associated data, thus keeping the model conforming to a current state of the entity being modelled.

One embodiment generates a set of variations of an existing task, and prioritizes simulation and execution of the variations according to their similarity with an existing task. Putting a higher priority on one or a few of the most similar tasks relative to other task variations can improve the speed of discovering a generated task meeting a success criterion.

The manner of digital twin modelling using task keyword analysis described herein is unavailable in the presently available methods in the technological field of endeavor pertaining to digital twin modelling. A method of an embodiment described herein, when implemented to execute on a device or data processing system, comprises substantial advancement of the functionality of that device or data processing system in extracting a set of tasks from workflow data, extracting a set of keywords from a task, expanding the set of keywords to include a new keyword with a semantic relationship to a keyword in the set of keywords, using the expanded set of keywords to generate a new task, and adjusting, based on a result of execution of the new task, a model.

The illustrative embodiments are described with respect to certain types of models, workflows, tasks, keywords, success criteria, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

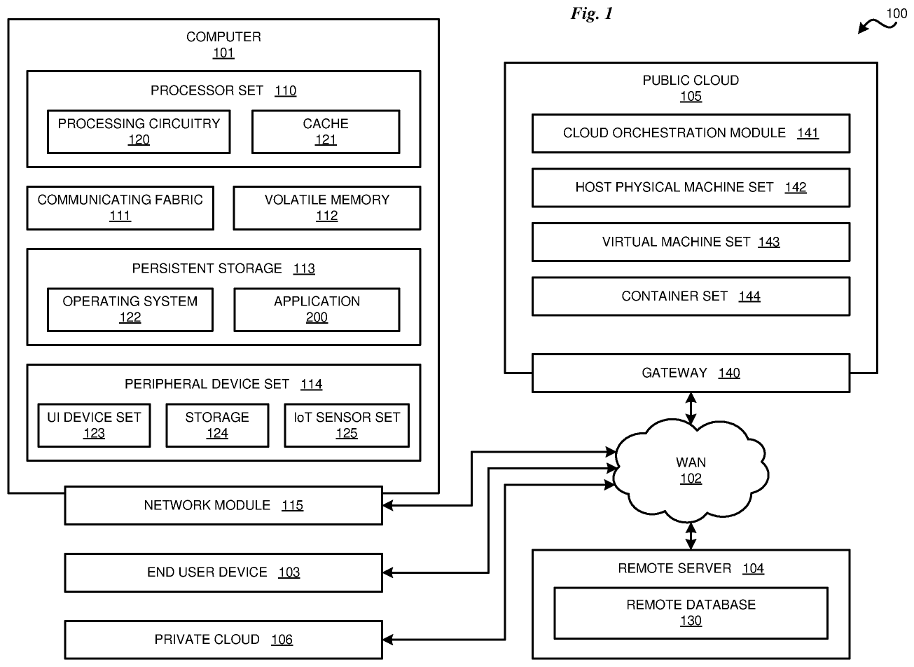

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a digital twin modelling using task keyword analysis embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single-or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

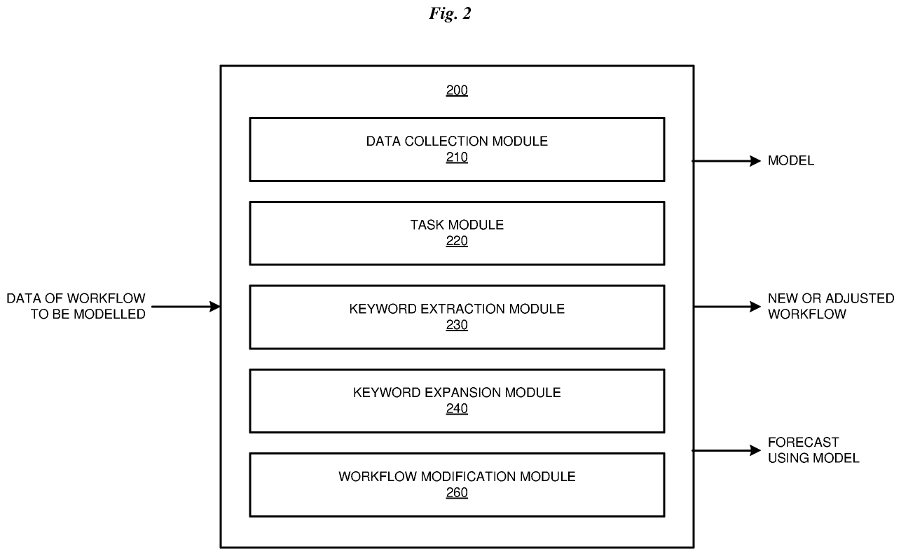

With reference to FIG. 2, this figure depicts a block diagram of an example configuration for digital twin modelling using task keyword analysis in accordance with an illustrative embodiment. Application 200 is the same as application 200 in FIG. 1.

Data collection module 210 receives workflow data of an entity or system to be modelled. Some non-limiting examples of workflow data are lifecycle data of components of the entity, organization data of an organization managing the entity, amounts and types of physical objects and data entering the entity, moving internally among portions of the entity, and exiting the entity, as well as data of the manner in which portions of the entity affect other portions of the entity and data of an environment of the entity. For example, in a data center being modelled, workflow data might include data entering and exiting systems installed in the data center, data of a current state of each of the systems and the building in which the systems are located, and current and forecast weather for the area in which the data center is located.

Task module 220 extracts a set of tasks from workflow data. One implementation of module 220 generates a task name, a text string uniquely identifying a task. Another implementation of module 220 generates a natural language description of a task. Another implementation of module 220 generates an action, a modification of the environment caused by the execution of a task. Another implementation of module 220 generates one or more preconditions, Boolean expressions that must be true before the action(s) of the task can take place. Another implementation of module 220 generates one or more postconditions, Boolean expressions that must be true after the action(s) of the task take place. Another implementation of module 220 generates one or more attributes or characteristics of a task, which indicate the type and quantity of resources necessary for the execution of the task, ab actor responsible for the task, the task's security requirements, whether or not the task is reversible, and the like. Another implementation of module 220 generates one or more exceptions, which provide information on how to handle abnormal events, typically in <event, action> pairs.

Keyword extraction module 230 extracts a set of keywords from a task. Keywords are informative words that indicate content. For example, for a task named “adjust the temperature”, “adjust” and “temperature” are keywords because they convey information about the task, but “the” does not convey information about this task in particular and thus is not a keyword. Keywords need not be single complete words, and can also be word fragments and multi-word phrases. Keywords need not all be in the same human language.

Keyword expansion module 240 expands the set of keywords by including one or more new keywords with a semantic relationship to a keyword already in the set of keywords. Some non-limiting examples of semantic relationships between keywords are synonyms of a keyword, antonyms of a keyword, variations of a keyword (e.g., variant spellings or different endings of the same root word), homonyms of a keyword, typical collocations and associations (i.e., additional words typically found in proximity to or otherwise associated with a keyword), derivatives of a keyword, phrases that include a keyword, actions or phenomena that typically affect a keyword, and the like. For example, for the keyword “adjust”, some additional keywords might be “increase”, “decrease”, “turn up”, “turn down”, and “alter” (all synonyms). As another example, for the keyword “temperature” some additional keywords might be “raised temperature”, “lowered temperature”, “suitable temperature”, “constant temperature”, “body temperature”, “air temperature”, “room air temperature”, “snow”, “ice”, “thermometer”, and “fire”.

One implementation of application 200 maintains a repository of keywords for use as new keywords. Another implementation of application 200 uses an already-existing repository of keywords as a source of new keywords.

Workflow data, tasks extracted from workflow data, and the expanded set of keywords are collectively referred to as a model. The model is searchable by matching a keyword, phrase, or text string, and by using a keyword as a term. The model is also usable to generate a forecast of a future state of the workflow being modelled, for example of when maintenance will be required on a modelled component or when an amount of material will be needed.

Because the model includes proprietary data of a business, one implementation of application 200 maintains model data in a private cloud or other system accessible to those authorized to view and use the business' proprietary data. Another implementation of application 200 maintains the model in two portions: workflow data, tasks extracted from workflow data, and keywords extracted from tasks are maintained in a private cloud or other access-restricted system, while deduced data (i.e., keywords deduced from the original keywords extracted from tasks) are maintained in a public cloud or other publicly-available system. One implementation of application 200 maintains both portions in the same format, for ease of use.

Workflow modification module 260 uses the expanded set of keywords to generate a new task. In one embodiment, the new task is a variation of an existing task, such as an addition, removal, or substitution of a keyword in a task attribute, input or output condition, actor, or other portion of data describing a task.

Module 260 simulates execution of the generated task, in isolation or as part of a workflow being modelled. If a result of the simulation meets a success criterion, module 260 causes execution of the generated task in the entity being modelled. If a result of the simulation does not meet a success criterion, module 260 uses the simulation results to generate a different variation of the task and repeats the simulation and evaluation.

If execution of the generated task in the entity being modelled meets a success criterion and consequently the generated task is implemented in the entity being modelled, application 200 adjusts the model to include the generated task and its associated data, thus keeping the model conforming to a current state of the entity being modelled.

One implementation of application 200 generates a set of variations of an existing task, and prioritizes simulation and execution of the variations according to their similarity with an existing task. Putting a higher priority on one or a few of the most similar tasks relative to other task variations can improve the speed of discovering a generated task meeting a success criterion.

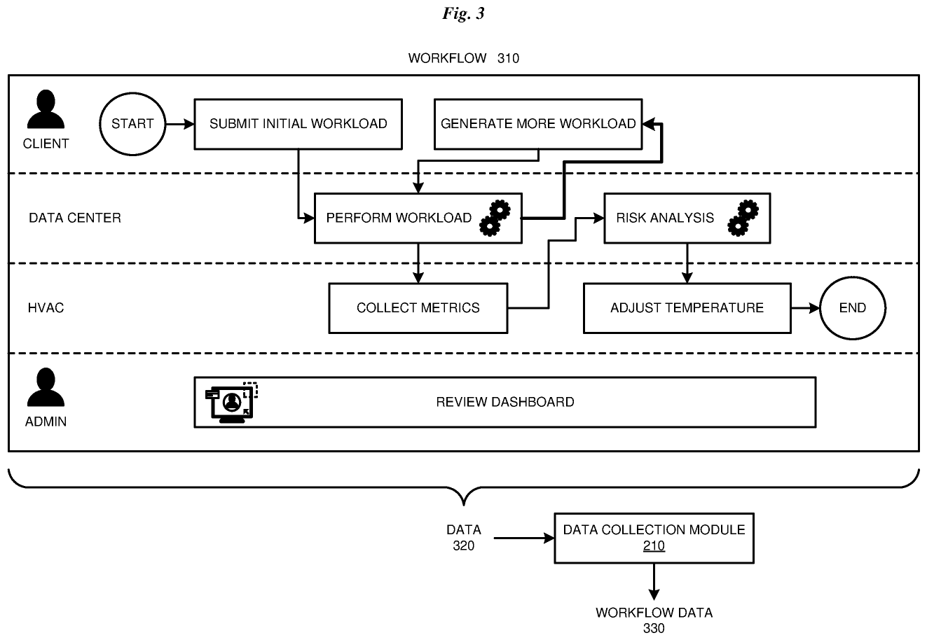

With reference to FIG. 3, this figure depicts an example of digital twin modelling using task keyword analysis in accordance with an illustrative embodiment. The example can be executed using application 200 in FIG. 2. Data collection module 210 is the same as data collection module 210 in FIG. 2.

As depicted, data collection module 210 receives data 320 of workflow 310, an entity or system to be modelled. Data collection module 210 generates workflow data 330. Workflow 310 is workflow of an example data center being modelled. Workflow 310 includes “submit initial workload” and “generate more workload” tasks, generated by a client of the data center. Workflow 310 also includes a “perform workload” task, in which servers of the data center perform workload submitted by a client, and a “risk analysis” task in which risks to the servers are evaluated. Workflow 310 also includes two tasks of the building's heating, ventilation, and air conditioning (HVAC) system: “collect metrics” (e.g., of the temperature of a server room) and “adjust temperature”. In addition, workflow 310 includes a “review dashboard” task performed by a human responsible for monitoring the data center being modelled.

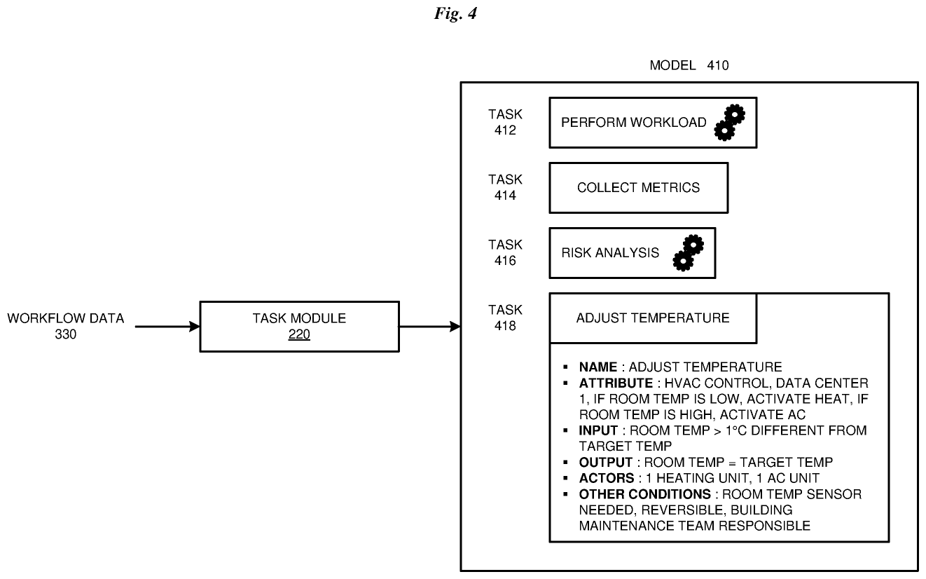

With reference to FIG. 4, this figure depicts a continued example of digital twin modelling using task keyword analysis in accordance with an illustrative embodiment. Task module 220 is the same as task module 220 in FIG. 2. Workflow data 330 is the same as workflow data 330 in FIG. 3.

Task module 220 extracts a set of tasks, including tasks 412, 414, 416, and 418, from workflow data 330. Tasks 412, 414, 416, and 418 are included in model 410, modelling workflow 310 in FIG. 3. Tasks 412, 414, 416, and 418 are depicted in FIG. 3 as part of workflow 310. FIG. 4 also depicts more detail of task 418, the “adjust temperature” task. Task 418 includes a task name of “adjust temperature” and attributes including HVAC control, Data Center 1, if room temperature is low, activate heat, and if room temperature is high, activate air conditioning (AC). An input condition of task 418 is that the room temperature is greater than 1° C. different from the room's target temperature. An output condition of task 418 is that the room temperature equals the target temperature. Actors of task 418 include one heating unit, and one AC unit. Other conditions of task 418 are that a room temperature sensor is needed, the task is reversible, and that the building maintenance team is responsible for the task.

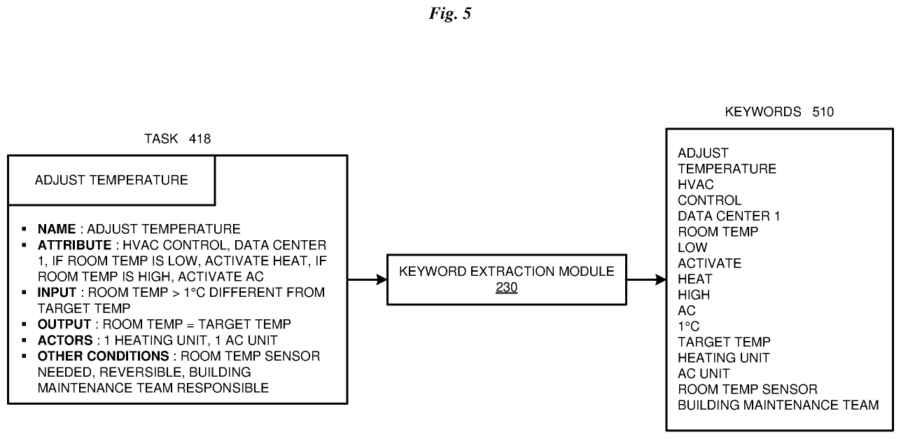

With reference to FIG. 5, this figure depicts a continued example of digital twin modelling using task keyword analysis in accordance with an illustrative embodiment. Keyword extraction module 230 is the same as keyword extraction module 230 in FIG. 2. Task 418 is the same as task 418 in FIG. 4.

As depicted, keyword extraction module 230 has extracted keywords 510 from task 418.

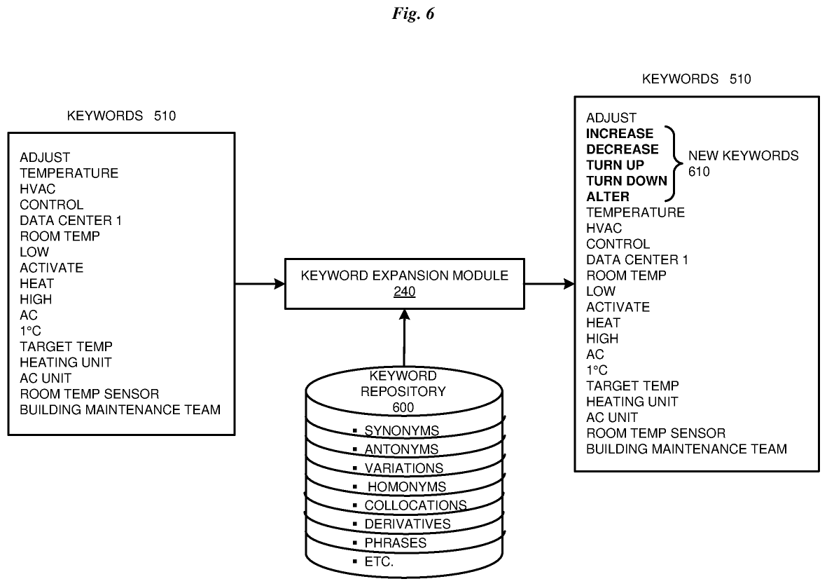

With reference to FIG. 6, this figure depicts a continued example of digital twin modelling using task keyword analysis in accordance with an illustrative embodiment. Keyword expansion module 240 is the same as keyword expansion module 240 in FIG. 2. Keywords 510 is the same as keywords 510 in FIG. 5.

As depicted, keyword expansion module 240 has expanded keywords 510 by including new keywords 610, with a semantic relationship to a keyword already in keywords 510, using keyword repository 600. In particular, new keywords 610 are all synonyms of “adjust”, a keyword in keywords 510.

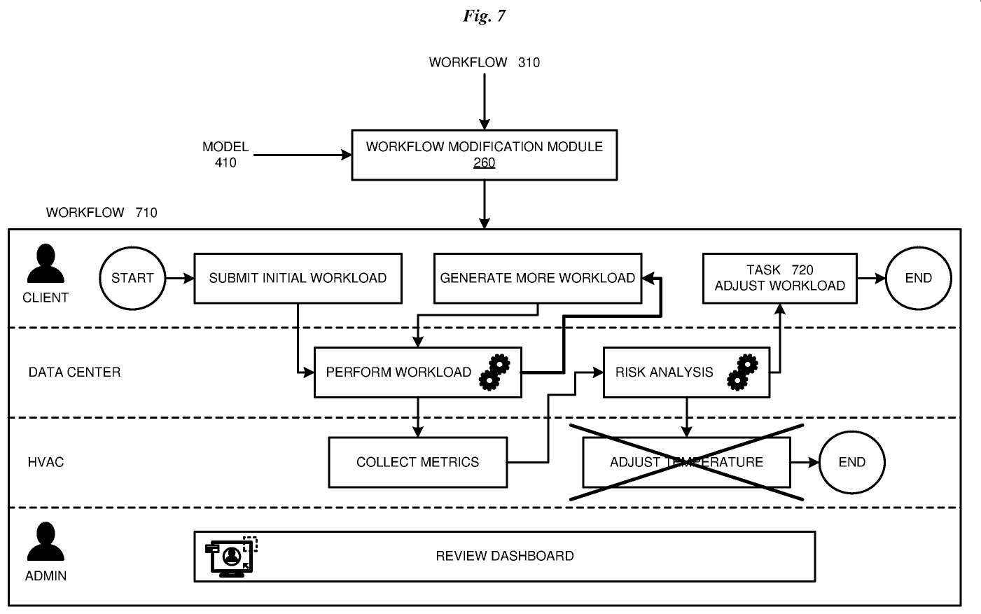

With reference to FIG. 7, this figure depicts a continued example of digital twin modelling using task keyword analysis in accordance with an illustrative embodiment. Workflow modification module 260 is the same as workflow modification module 260 in FIG. 2. Workflow 310 is the same as workflow 310 in FIG. 3. Model 410 is the same as model 410 in FIG. 4. Model 410 includes workflow data 330, tasks extracted from workflow data 330, and keywords 510 (including new keywords 610).

Workflow modification module 260 uses model to generate task 720, thus changing workflow 310 to workflow 710. Task 720 is a variation of task 418 with a task name of “adjust workload” and attributes including if room temperature is high, reduce server workload (e.g., by moving some workload to another data center), and the same input conditions as the original “adjust temperature” task. If a result of simulating task 720 meets a success criterion, application 200 causes execution of task 720 in workflow 710. If execution of task 720 in workflow 710 meets a success criterion and consequently task 720 is implemented in workflow 710, application 200 adjusts model 410 to include task 720 and its associated data.

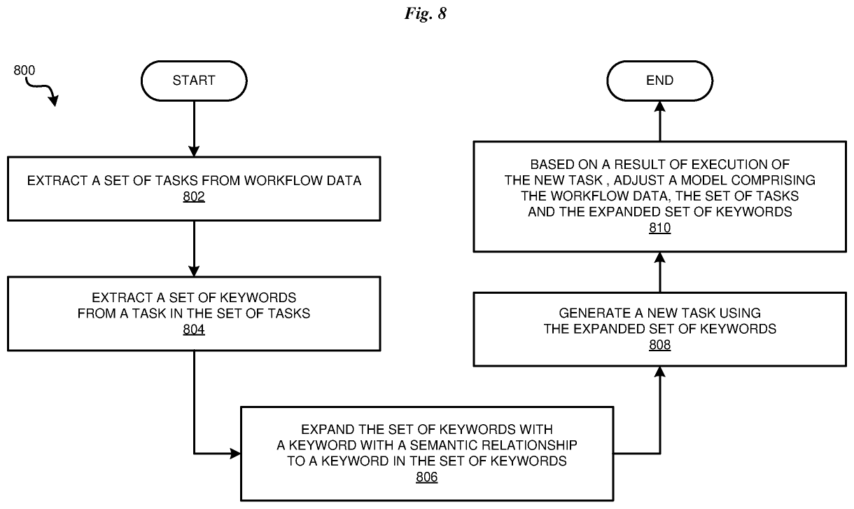

With reference to FIG. 8, this figure depicts a flowchart of an example process for digital twin modelling using task keyword analysis in accordance with an illustrative embodiment. Process 800 can be implemented in application 200 in FIG. 2.

In block 802, the application extracts a set of tasks from workflow data. In block 804, the application extracts a set of keywords from a task in the set of tasks. In block 806, the application expands the set of keywords with a keyword with a semantic relationship to a keyword in the set of keywords. In block 808, the application generates a new task using the expanded set of keywords. In block 810, the application, based on a result of execution of the new task, adjusts a model comprising the workflow data, the set of tasks, and the expanded set of keywords. Then the application ends.

Thus, a computer implemented method, system or apparatus, and computer program product are provided in the illustrative embodiments for digital twin modelling using task keyword analysis and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
extracting, from workflow data of a system, a set of tasks;
extracting, from a task in the set of tasks, a set of keywords;
expanding, into an expanded set of keywords, the set of keywords, the expanded set of keywords comprising a new keyword with a semantic relationship to a keyword in the set of keywords;
generating, using the expanded set of keywords, a new task; and
adjusting, based on a result of execution of the new task, a model of the system, the model comprising the workflow data, the set of tasks, and the expanded set of keywords.

2. The computer-implemented method of claim 1, further comprising:
generating, by simulating execution of the new task, a result of simulated execution of the new task.

3. The computer-implemented method of claim 2, further comprising:
causing, responsive to determining that the result of simulated execution of the new task meets a success criterion, execution of the new task by the system.

4. The computer-implemented method of claim 2, further comprising:
regenerating, responsive to determining that the result of simulated execution of the new task does not meet a success criterion, using the expanded set of keywords, the new task, the regenerating resulting in a second new task.

5. The computer-implemented method of claim 4, further comprising:
causing, responsive to determining that a result of simulated execution of the second new task meets a success criterion, execution of the second new task by the system.

6. The computer-implemented method of claim 5, further comprising:
causing, responsive to determining that the result of simulated execution of the second new task meets the success criterion, execution of the second new task by the system.
incorporating, into the model responsive to determining that the result of simulated execution of the second new task meets the success criterion, the second new task.

7. A computer program product comprising one or more computer readable storage medium, and program instructions collectively stored on the one or more computer readable storage medium, the program instructions executable by a processor to cause the processor to perform operations comprising:
extracting, from workflow data of a system, a set of tasks;
extracting, from a task in the set of tasks, a set of keywords;
expanding, into an expanded set of keywords, the set of keywords, the expanded set of keywords comprising a new keyword with a semantic relationship to a keyword in the set of keywords;
generating, using the expanded set of keywords, a new task; and
adjusting, based on a result of execution of the new task, a model of the system, the model comprising the workflow data, the set of tasks, and the expanded set of keywords.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising:
generating, by simulating execution of the new task, a result of simulated execution of the new task.

11. The computer program product of claim 10, further comprising:
causing, responsive to determining that the result of simulated execution of the new task meets a success criterion, execution of the new task by the system.

12. The computer program product of claim 10, further comprising:
regenerating, responsive to determining that the result of simulated execution of the new task does not meet a success criterion, using the expanded set of keywords, the new task, the regenerating resulting in a second new task.

13. The computer program product of claim 12, further comprising:
causing, responsive to determining that a result of simulated execution of the second new task meets a success criterion, execution of the second new task by the system.

14. The computer program product of claim 13, further comprising:
causing, responsive to determining that the result of simulated execution of the second new task meets the success criterion, execution of the second new task by the system.

15. A computer system comprising a processor and one or more computer readable storage media, and program instructions collectively stored on the one or more computer readable storage media, the program instructions executable by the processor to cause the processor to perform operations comprising:
extracting, from workflow data of a system, a set of tasks;
extracting, from a task in the set of tasks, a set of keywords;
expanding, into an expanded set of keywords, the set of keywords, the expanded set of keywords comprising a new keyword with a semantic relationship to a keyword in the set of keywords;
generating, using the expanded set of keywords, a new task; and
adjusting, based on a result of execution of the new task, a model of the system, the model comprising the workflow data, the set of tasks, and the expanded set of keywords.

16. The computer system of claim 15, further comprising:
generating, by simulating execution of the new task, a result of simulated execution of the new task.

17. The computer system of claim 16, further comprising:
causing, responsive to determining that the result of simulated execution of the new task meets a success criterion, execution of the new task by the system.

18. The computer system of claim 16, further comprising:
regenerating, responsive to determining that the result of simulated execution of the new task does not meet a success criterion, using the expanded set of keywords, the new task, the regenerating resulting in a second new task.

19. The computer system of claim 18, further comprising:
causing, responsive to determining that a result of simulated execution of the second new task meets a success criterion, execution of the second new task by the system.

20. The computer system of claim 19, further comprising:
causing, responsive to determining that the result of simulated execution of the second new task meets the success criterion, execution of the second new task by the system.
incorporating, into the model responsive to determining that the result of simulated execution of the second new task meets the success criterion, the second new task.
